(19) United States
(12) Patent Application Publication
(10) Pub. No.: US 2010/0309492 A1
(43) Pub. Date: Dec. 9, 2010

(54) FLATBED PRINTER

(75) Inventor: William Ronald Stuart Baxter, Cambridge (GB)

Correspondence Address: HARNESS, DICKEY & PIERCE, P.L.C., P.O. BOX 828, BLOOMFIELD HILLS, MI, 48303, US

(73) Assignee: INCA DIGITAL PRINTERS LIMITED, Cambridge (GB)

(21) Appl. No.: 12/864,682

(22) PCT Filed: Feb. 4, 2009
(86) PCT No.: PCT/GB2009/050108

§ 371 Date: Jul. 27, 2010

(30) Foreign Application Priority Data
Feb. 4, 2008 (GB) 0802014.1

(51) Int. Cl. G06K 15/10

(52) U.S. Cl. 358/1.8; 358/1.1

(57) ABSTRACT

An inkjet printer (10) is described which includes two substrate support beds (30, 40). The printer can print onto a first substrate on one of the support beds (30) while a second substrate is loaded onto and/or unloaded from the second support bed (40). In this way, the printing operation can be made more efficient and the throughput of the printer can be improved.

The invention relates to printers. Aspects of the invention described herein relate to flatbed printers. Examples of the invention find particular application in relation to inkjet printers.

In flatbed inkjet printers, the substrate to be printed is held or supported on a bed, for example a flat table. During the printing of an image, relative movement is provided between the substrate and a printhead array, for example by way of movement of one or both of the bed and the printhead array. Examples of flatbed inkjet printers are the ONSET and SPYDER printers of Inca Digital Printers Limited, GB, and the TEMPO printer of Nur Macroprinters. For these three examples, the relative movement of the table and printhead array is arranged respectively such that:
the printhead array is stationary during printing, while the table moves, and the printhead array is indexed between passes of the table (ONSET)
the printhead array moves during printing, and the beam providing the printhead array axis is indexed between passes of the table (SPYDER)
the printhead array moves during printing, and the table is indexed between passes of the printhead array (TEMPO).

These printers are given only as examples, and it should be understood that aspects of the invention are applicable to other similar printers, and other printers operating in a different manner.

The cost of an inkjet printer, especially one of high throughput, is often dominated by the cost of the printheads and their associated equipment such as drive electronics, ink supply and thermal management system. In order to maximise the value-for-money of the printer (measured by throughput divided by price) it is desirable to arrange that the printheads are operating for the greatest possible proportion of the time.

In the operation of a flatbed printer, it is necessary to load the substrate to be printed onto the bed prior to printing, and then to unload the substrate from the bed after printing. It will therefore be seen that during the time taken for unloading/loading of the substrate, no printing is carried out, thus affecting the throughput of the printer. In an example of a high throughput printer, the total printing time for a substrate might be sixteen seconds, but the load/unload process at the end of each cycle might add another ten seconds onto the total cycle time. In this example, the printhead array is operating only for about 60% of the time.

Aspects of the present invention seek to increase the proportion of the cycle time during which printing occurs.

Accordingly, in a first aspect of the invention, there is provided an inkjet printer for printing an image on a substrate, the printer comprising a first substrate support member for supporting a first substrate, and further comprising a second substrate support member for supporting a second substrate, wherein preferably the printer is adapted for printing on the first substrate on the first substrate support member while a second substrate is loaded and/or unloaded from the second substrate support member.

In this way the printing of one substrate or set of substrates can proceed while the previous substrate is unloaded and the next is loaded. Thus the idle time for the printheads can be reduced, thereby increasing throughput of the printer.

Preferably the substrate support member comprises a bed. Preferably the bed is adapted to hold one or more substrates, for example flat rigid substrates, in the printer during printing, preferably so that a substantially flat surface of the substrate is presented to the printheads for printing. Preferably a flatbed printer is to be understood to be a printer having such a bed. It should be understood that the substrate itself might not be flat. The substrate may comprise a three-dimensional object.

The substrate support member may comprise a table. Preferably the table, has a substantially flat surface for supporting a substrate, for example a substrate comprising sheet material.

Preferably the printer is a flatbed printer, and two or more beds are provided for supporting the substrate. The beds may comprise any suitable further means for holding the substrate to the bed. For example, where the substrate comprises a sheet material, a suction device may be provided to hold the sheet to the bed. Alternatively, or in addition, the bed may be provided with other means, for example magnetic chucks, clamps or jigs to hold or support one or more substrates on the bed. Such other means may be suitable, for example, where the substrate is other than sheet material. For example, the printer may be used to print onto three dimensional objects, for example machine parts, packaging or consumer products.

Therefore the printer preferably comprises more than one print bed. In many arrangements, the printer preferably comprises two beds or tables, although it is envisaged that additional beds or tables might be used.

Thus a broad aspect of the invention provides a flatbed printer comprising more than one print bed, each print bed being adapted to support a substrate for printing.

The substrate support members are preferably movable independently from each other.

The substrate support members may be movable independently from each other during printing. This movement may be in a printing direction for example parallel to the axis of printer. The movement may be a reciprocating movement.

In a preferred example, each substrate support member is movable between a loading region in which a substrate can be loaded and/or unloaded from the member, and a printing region in which printing of the substrate is carried out. Preferably each substrate support member has its own loading region in which it can be parked for loading/unloading. In this way, one substrate support member can be in the loading region being loaded/unloaded, while the other is in the printing region.

Preferably the loading region is located adjacent the printing region, conveniently in a direction parallel to the print axis along which the substrate is moved during printing. This can lead to simpler construction, for example where the print bed is moved along rails oriented along the print axis direction. Other arrangements could, however, be used. For example, the print bed could be translated perpendicular to the print axis to the loading region and/or could be moved in a vertical direction away from the print region.

Preferably the substrate support members, for example the print tables, can be releasably joined together. In this way, the printer includes an optional mode for printing onto large substrates which are bigger than the size of one table.

The substrate support members may be fixed relative to each other during printing.

The printer may further include a printhead array movable between a first printing region associated with the first support member, and a second printing region associated with the second support member.

Thus the printhead array is movable between a first working region and a second working region. While the printhead array is carrying out printing in the first working region, unloading/loading of the substrate(s) is being carried out in the second working region, and vice versa. Preferably, the first working region and second working region are sufficiently separate so that the loading/unloading and printing operations can be carried out without interfering with each other.

While the print tables or other support members are preferably fixed during printing, they may move during the printing cycle, for example to index the substrates between printing scans.

The two support members may comprise two regions of a bed in a printer.

Preferably the support members can be moved independently from each other, for example to adjust their heights independently to allow for different thickness of substrate.

It will be appreciated that more than two printing regions and loading/unloading regions can be provided.

The first printing region and second printing region may conveniently be arranged adjacent to each other in a direction parallel to the print axis.

Preferably the print axis is along the direction of printing, substantially perpendicular to the direction of indexing of the printheads relative to the substrate between print scans. The printing regions may be arranged end to end, side by side, or any other appropriate configuration.

The substrate support member may be releasably attachable to a print bed of the printer. For example, the substrate support member may be releasably attachable to a transport mechanism for moving the substrate during printing. The substrate support member may be releasably attachable to a printer bed or other part of the printer.

In many examples, the substrate support member will comprise a flatbed table for supporting the substrate and for moving it as required relative to the printhead array, the support member may comprise a separate device which can be releasably attached to a part of the printer.

In such arrangements, preferably the printer is adapted so that the substrate support member can be releasably attached to a printer bed or other member for a printing operation to be carried out, and then moved away from the printer bed to a loading region in which the substrate(s) can be loaded/unloaded from the substrate support member.

For example, a single substrate transport member may be provided in the printer for moving the substrate relative to the printheads during printing, two (or more) substrate support members being provided for engagement with the transport member. Each substrate support member is preferably arranged for movement between a position in which it is engaged with the transport mechanism for the printing operation, and a loading position, away from the printing region, where loading and unloading can be carried out (preferably while another substrate support mechanism is in the printing region).

Preferably the printer is a flatbed inkjet printer.

An aspect of the invention provides a flatbed inkjet printer having more than one bed, each bed being adapted to support a substrate during printing. Preferably the beds are movable independently of each other.

Another aspect of the invention provides an inkjet printer for printing on a substrate, the printer having more than one print regions in which a substrate can be printed, preferably wherein printing of a first substrate can be carried out in a first print region while a second substrate is loaded/unloaded in a second print region.

An aspect of the invention provides an inkjet printer for printing on a substrate in a printing region, the printer further having a loading region, separate from the printing region, in which a substrate can be loaded and/or unloaded from the printer.

Also provided by the invention is an inkjet printer for printing onto a substrate, the printer being adapted to carry out a printing operation on a first substrate while a second substrate is being loaded onto and/or unloaded from the printer.

According to a further aspect of the invention, there is provided a method of printing a plurality of substrates in an inkjet printer having a first substrate support member for supporting a first substrate and a second substrate support member for supporting a second substrate, wherein the method comprises printing on the first substrate on the first substrate support member and loading and/or unloading a second substrate from the second substrate support member during the printing of the first substrate.

The method may comprise the steps of: moving the first substrate support member to a loading region; loading a substrate onto the first substrate support member; moving the second substrate support member to a printing region; and printing an image on a substrate in the printing region.

The method may further comprise the steps of: moving the second substrate support member to a loading region; unloading a printed substrate from the second substrate support member; loading a further substrate onto the second substrate support member; moving the first substrate support member to a printing region; and printing an image on a substrate in the printing region.

Preferably the loading region for the first substrate support member is separate from the loading region of the second support member, although the same region could be used in some arrangements.

The method may further comprise the steps of: providing a printhead array; moving the printhead array to the first substrate support and carrying out a first printing operation; loading a substrate onto the second substrate support during the first printing operation.

The method may further comprise the steps of: moving the printhead array to the second substrate support and carrying out a second printing operation; unloading the printed substrate from the first substrate support during the second printing operation.

The substrate supports may be kept substantially stationary during the first and second printing operations. In some arrangements, the substrate supports may be moved during printing, or during the print cycle.

Also provided by the invention is a method of printing onto a plurality of substrates in an inkjet printer, the method comprising carrying out a printing operation on a first substrate while a second substrate is being loaded onto and/or unloaded from the printer.

The invention further provides a substrate support member arrangement for an inkjet printer as herein described, or for use in a method as herein described.

The invention also provides a method and/or apparatus being substantially as herein described, preferably with reference to FIG. 2 or FIG. 3.

Any feature in one aspect of the invention may be applied to other aspects of the invention, in any appropriate combination. In particular, method aspects may be applied to apparatus aspects, and vice versa.

Preferred features of the present invention will now be described, purely by way of example, with reference to the accompanying drawings, in which:

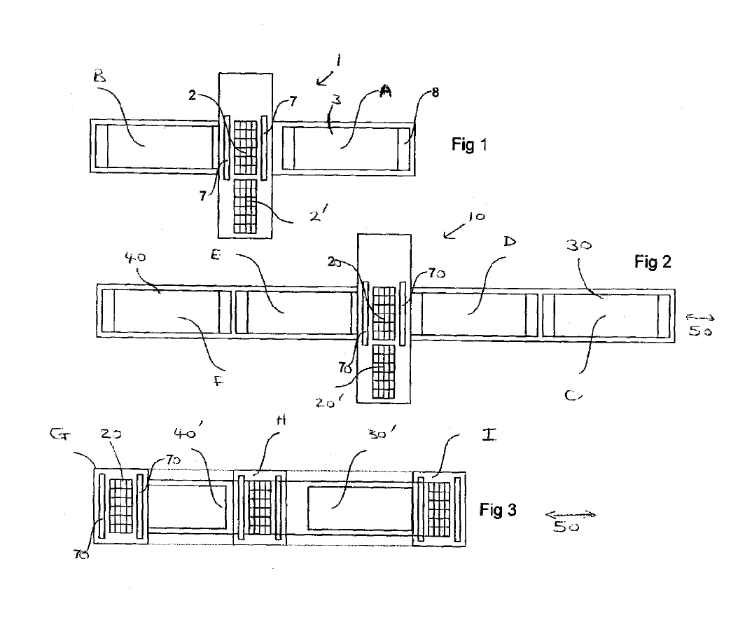

FIG. 1 shows a schematic plan view of a known printer illustrating the movement of the table;

FIG. 2 shows a schematic plan view of a printer in accordance with an embodiment, and illustrates the movement of the tables;

FIG. 3 shows a schematic plan view of a printer in accordance with a further embodiment, and illustrates the movement of the printhead array.

FIG. 1 shows schematically a plan view of a flatbed inkjet printer which operates in the manner of the ONSET printer of Inca Digital Printers Limited. The printer 1 comprises a bed in this example comprising a table 3 for supporting a substrate to be printed. The table 3 includes light guards 8. The printer also includes a printhead array 2 which includes an arrangement of inkjet printheads, and also UV curing lamps 7 for effecting cure of the ink after it has been deposited onto the substrate during printing. The printhead array 2 and UV curing lamps 7 are mounted in a housing. The printhead array 2 can be moved transversely away from the print table 3 to a retracted position 2′, for example for maintenance.

FIG. 1 shows the table 3 in its “park” position A where loading and unloading of the substrate takes place. During the printing operation, the table 3 moves from its park position at A, under the UV curing lamps 7 and the printhead array 2 to the position shown at B, then back again under the printhead array 2 and curing lamps 7. During each such print stroke, ink is emitted from the printhead array 2 and is cured by the curing lamps 7. The printhead array 2 indexes slightly between each print stroke in order to fill in the gaps between individual grid points and produce the full image.

When the print is finished, the table 3 returns to its park position A. The printed substrate is then unloaded and a fresh substrate is loaded onto the table 3. The cycle then starts again.

It can be seen that, during the loading and unloading of the substrate, the print engine (which is the most costly part of the printer) is idle. For a high throughput printer, the total print time might be sixteen seconds, but the load/unload process at the end of each cycle might add another ten seconds onto the total cycle time.

FIG. 2 shows how this wasted time can be used. In this printer 10, the printhead array 20 and UV curing lamps 70 are arranged in a similar manner to that shown for FIG. 1.

However, in this case, two tables, 30 and 40, run on a lengthened printer axis. Each table has a “park” position (C for first table 30, and F for second table 40) where the substrate is loaded and unloaded from the table. During printing, a table moves in the printing region under the printhead array 20 and UV curing lamps 70 between positions D and E along the main print axis 50. When printing is finished for that substrate, the table 30, 40 returns to its respective park position C, F.

In the operation of the printer 10, while one table is used for printing (moving between positions D and E), the other table is parked at its respective park position C, F, allowing operators (or an automated system) to unload the printed substrate and load a fresh one. When the print is complete on the active table, it moves to its park position, and the parked (and by now loaded) table moves immediately to begin its print cycle.

In this way, printing is carried out during a greater proportion of the print cycle time compared with the case where only one table is used. Theoretically this method could completely eliminate wasted cycle time due to load/unload cycles, although in practice a small gap would normally be allowed between the two tables as one takes over from the other.

The same principle can be applied to flatbed printers that use different architectures.

An example is shown in FIG. 3. Again, two tables 30′, 40′ are used, but in this case, the tables 30′, 40′ are generally fixed in place during printing, and the printhead array 20 (and UV curing lamps 70) moves along the main axis 50 of the machine during printing, indexing perpendicular to the main axis 50 between print passes. Each table 30′, 40′ is independently adjustable in height so as to allow for the printing of substrates of different thicknesses.

In the example shown in FIG. 3, the substrate on table 40′ is printed, with the printhead array moving between positions G and H. In the view shown in FIG. 3, the table is partly obscured by the printhead array. During this print cycle, the substrate for table 30′ can be loaded and unloaded. Then, when the print cycle on table 40′ is complete, the printhead array 20 moves to the other end of the machine along the main axis 50 to print the substrate on table 30′, leaving table 40′ clear of obstruction so that it can in turn be loaded and unloaded. During printing of the substrate for table 30′, the printhead array 20 moves between positions H and I, indexing perpendicular to the main axis 50 during the printing cycle, as appropriate.

Again, it will be seen that the idle time for the printhead array can theoretically be effectively eliminated as unloading/loading for one table can be carried out during printing a substrate on the other table.

While two specific examples have been described, it will be seen that other arrangements and modifications are possible.

For example, arrangements may be provided where a combination of movement of both the substrate table and the printhead array is provided during printing.

For the example shown with reference to FIG. 2, there may be an option for the two tables to be joined together so that oversize substrates may be printed. That would, of course, lose the advantage of the illustrated approach in reducing wasted cycle time, but it would give the option of printing very long substrates if required.

In some arrangements, more than two beds might be provided.

The beds might be of unequal sizes.

For some arrangements, it is preferable that, at the start of a print run, the bed is “masked”. For example, where a vacuum is used to hold the substrate to a table, an array of vacuum holes is provided across the table and a fan is provided under the table for applying suction. So, for instance, if a substrate is 1 m×2 m, and the bed is 1.6 m×3.2 m, the open area of the table is taped over with some material that will block off the vacuum holes; otherwise the fan will lose its suction. One advantage of the arrangements shown is that one bed can still print, in some examples at slightly reduced throughput, while the other is being masked—a process that can take several minutes.

Other possible arrangements are described above.

It will be understood that the present invention has been described above purely by way of example, and modification of detail can be made within the scope of the invention.

Each feature disclosed in the description, and (where appropriate) the claims and drawings may be provided independently or in any appropriate combination.

1. An inkjet printer for printing an image on a substrate, the printer comprising a first substrate support member for supporting a first substrate during printing of the first substrate, and further including a second substrate support member for supporting a second substrate during printing of the second substrate, wherein the printer is adapted for printing on the first substrate on the first substrate support member while a second substrate is loaded onto and/or unloaded from the second substrate support member.

2. A printer according to claim 1, wherein the substrate support member comprises a table.

3. A printer according to claim 2, wherein the printer comprises two tables.

4. A printer according to claim 1, wherein the substrate support members are movable independently from each other.

5. A printer according to claim 1, wherein the substrate support members are movable independently from each other during printing.

6. A printer according to claim 1, wherein each substrate support member is movable between a loading region in which a substrate can be loaded and/or unloaded from the member, and a printing region in which printing of the substrate is carried out.

7. A printer according to claim 1, wherein the substrate support members are fixed relative to each other during printing.

8. A printer according to claim 1, the printer including a printhead array movable between a first printing region associated with the first support member, and a second printing region associated with the second support member.

9. A printer according to claim 1, wherein the first printing region and second printing region are arranged adjacent to each other in a direction parallel to the print axis.

10. A printer according to claim 1, wherein the substrate support member is releasably attachable to a print bed of the printer.

11. (canceled)

12. A method of printing a plurality of substrates in an inkjet printer having a first substrate support member for supporting a first substrate during printing of the first substrate, and a second substrate support member for supporting a second substrate during printing of the second substrate, wherein the method comprises printing on the first substrate on the first substrate support member and loading and/or unloading a second substrate from the second substrate support member during the printing of the first substrate.

13. A method according to claim 12, wherein the method comprises the steps of:
moving the first substrate support member to a loading region;
loading a substrate onto the first substrate support member;
moving the second substrate support member to a printing region; and
printing an image on a substrate in the printing region.

14. A method according to claim 13, further comprising the steps of:
moving the second substrate support member to a loading region;
unloading a printed substrate from the second substrate support member;
loading a further substrate onto the second substrate support member;
moving the first substrate support member to a printing region; and
printing an image on a substrate in the printing region.

15. A method according to claim 12, further comprising the steps of:
providing a printhead array;
moving the printhead array to the first substrate support and carrying out a first printing operation;
loading a substrate onto the second substrate support during the first printing operation.

16. A method according to claim 15, further comprising the steps of:
moving the printhead array to the second substrate support and carrying out a second printing operation;
unloading the printed substrate from the first substrate support during the second printing operation.

17. A method according to claim 15, wherein the substrate supports are kept substantially stationary during the first and second printing operations.

18. (canceled)

19. A substrate support member arrangement for an inkjet printer according to claim 1.

20. (canceled)

21. (canceled)
